(19) United States
(12) Patent Application Publication
(10) Pub. No.: US 2013/0050997 A1
(43) Pub. Date: Feb. 28, 2013

(54) LIGHTING UNIT AND METHODS

(71) Applicants: Eric Bretschneider, Satellite Beach, FL (US); Zach Berkowitz, San Francisco, CA (US); Randall Sosnick, Mill Valley, CA (US)

(72) Inventors: Eric Bretschneider, Satellite Beach, FL (US); Zach Berkowitz, San Francisco, CA (US); Randall Sosnick, Mill Valley, CA (US)

(21) Appl. No.: 13/272,017

(22) Filed: Oct. 12, 2011

Related U.S. Application Data
(60) Provisional application No. 61/528,729, filed on Aug. 29, 2011.

(51) Int. Cl. F21L 4/02; F21L 4/00; F21V 17/00; F21V 21/00

(52) U.S. Cl. 362/190; 362/382; 362/249.01; 29/401.1; 29/825

(57) ABSTRACT

The invention provides systems and methods for providing illumination. A lighting unit, which may be an LED based fluorescent tube replacement, may comprise a power supply and an LED portion produced as separate modules and coupled in a manner that allows the light module and the power supply module to be connected and separated in a reproducible manner. The removable power supply module may enhance the serviceability, customizability and upgradability of the LED based system.

### CROSS-REFERENCE

This application claims the benefit of U.S. Provisional Application No. 61/528,729, filed Aug. 29, 2011, which application is incorporated herein by reference.

### BACKGROUND OF INVENTION

Fluorescent lamps are widely used for lighting in commercial buildings, residential spaces, as well as on transit buses and in outdoor lighting. Fluorescent lighting provides some advantages, such as improved efficiency, over other lighting options such as incandescent lighting. However, there are several drawbacks. Fluorescent lamps fail under excessive vibration, require a high operating voltage, consume a large amount of power, generally have poor color quality, they cannot be started in cold temperatures or in humid environments, they emit light in 360 degrees about the length of the lamp such that much light is lost in reflection, and they contain mercury, making the lamps difficult to dispose of and hazardous to human health and the environment. LED based fluorescent tube replacements (FTRs) are a promising new technology to address the issues associated with the current generation of fluorescent lamps and provide even higher efficiencies, thus lowering energy consumption used for lighting.

Currently the cost of LED based FTRs is much higher than the fluorescent lamps they replace. The bulk of the production cost of an FTR comes from two components: the LED module and the power supply. To date, these components have been assembled in a complete module so that failure of one component required replacement of the entire unit. In some cases, end users may wish to add capabilities to the power supply such as compatibility with dimming circuits, occupancy sensing or daylight harvesting. While having these features may enable further energy savings, these new features also require replacement of the entire unit.

Typical failures in LED based FTRs occur in the power supply. The reliability/lifetime of electronic components and in particular electrolytic capacitors is much shorter than that of state of the art LEDs. The cost of these components and in most cases even the entire power supply is much less than that of the LEDs used in the light module. Thus the failure of the lowest cost components can trigger an expensive replacement of the entire unit.

When new features are added to the power supplies and control circuits, customers are similarly forced to replace the entire unit to take advantage of capabilities that may further enhance energy saving opportunities. The ability to replace power supplies provides a “future proofing” for customers in that they can take advantage of more efficient power supplies, or new features such as compatibility with dimmer devices, daylight harvesting, occupancy sensing. New features may also include compatibility with wired, wireless or optical control methods and protocols.

Therefore, a need exists for improved systems and methods of LED based FTRs to enable tailored FTR solutions.

### SUMMARY OF INVENTION

The invention provides systems and methods for providing illumination.

In accordance with an aspect of the invention, a lighting unit may be provided, such as an LED based fluorescent tube replacement (FTR). The lighting unit may comprise a power supply and a lighting portion that may be produced as separate modules and that may be coupled in a manner that allows the light module and the power supply module to be connected and separated in a reproducible manner.

Another aspect of the invention provides methods of coupling said modules, including various means to replace, service, upgrade and customize a lighting unit in accordance with the present invention.

Aspects of the invention may provide a novel lighting unit with significant advantages over the prior art. For example, new features related to the power supply, including but not limited to various energy saving and “smart” technologies, line voltage compatibility features and wired, wireless or optical based communications for light control, may be added without replacement of the entire unit. Such additional features may be added through a simple procedure and at a minimal cost.

A further benefit of the invention is that in the event of a failure of the power supply module, the failed component may be replaced at a substantial savings to the end user.

The invention may further advantageously provide a novel unit for replacing existing fluorescent tube lighting units. An FTR in accordance with the present invention may provide significantly enhanced flexibility in tailoring the FTR to satisfy a wide range of user lighting requirements.

An additional benefit of the invention is that the manufacturing cost of FTRs may be reduced, since an entire line of FTRs could be produced using a single module. Power supplies with different configurations and capabilities may be produced independently and added to the lighting modules as needed to produce a wide range of final products.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is an environmental perspective view of a lighting unit and a lighting fixture.

FIG. 1B is a fragmented perspective view showing the installation of one embodiment of a lighting unit in a lighting fixture.

FIG. 2 shows a fragmented perspective view of the components of a lighting unit in accordance with a preferable embodiment of the present invention, with details of a light engine exposed.

FIG. 3 shows a perspective view of one end of an assembled lighting unit.

FIG. 4 shows a perspective view of an assembled lighting unit as viewed from the direction of illumination.

FIG. 5 is a conceptual view of a lighting unit with customizable functionality incorporated in removable end caps.

FIG. 6A shows the fragmented perspective view of FIG. 2 from the opposite direction.

FIG. 6B illustrates one possible arrangement of a lighting unit. Here, a light engine and an adaptor have been connected.

FIG. 6C illustrates a lighting unit, where a power supply has been connected to the light engine and adaptor assembly in FIG. 6B.

### DETAILED DESCRIPTION OF INVENTION

The invention provides systems and methods for providing illumination. Various aspects of the invention described herein may be applied to any of the particular applications set forth below or for any other types of lighting units. The invention may be applied as a standalone system or method, or as part of an integrated illumination system. It shall be understood that different aspects of the invention can be appreciated individually, collectively, or in combination with each other.

Systems

An aspect of the invention relates to lighting units which may be used for illumination. A lighting unit may provide light suitable for general illumination. A lighting unit may be used as a replacement lamp for conventional lighting fixtures or as a standalone light source. A lighting unit may be used as a replacement for lighting fixtures of various types (e.g., fluorescent lighting fixtures, halogen lighting fixtures, incandescent lighting fixtures, gas discharge lamps, plasma lamps). Alternatively, a lighting unit is a unique lighting unit not intended to replace other lighting fixtures. A lighting unit may be highly efficient and may provide good quality light while having the potential to be manufactured at low cost.

The lighting unit may be used for general illumination or specialty lighting applications such as phototherapeutic applications, grow lighting, display lighting, architectural lighting, medical lighting, inspection lighting, decorative lighting, backlighting, signage, and other lighting applications. The lighting unit can be used for indirect or direct illumination, or a combination thereof. In some embodiments, the lighting unit may be provided for indoor applications. Alternatively, the lighting unit may be provided for the outdoors. The lighting unit can provide ambient or background light, or directed light. The lighting unit may be freestanding or portable, fixed (e.g., recessed, surface-mounted, outdoor), or for special purpose. In some implementations, the lighting unit may be provided for a ceiling, wall, or floor fixture. The lighting unit could be applied as a table lamp.

As previously discussed, the lighting unit could be provided as a replacement for a conventional lighting fixture. Any description herein of replacing a particular type of conventional lighting fixture (e.g., fluorescent) can be applied to other types of conventional lighting fixtures.

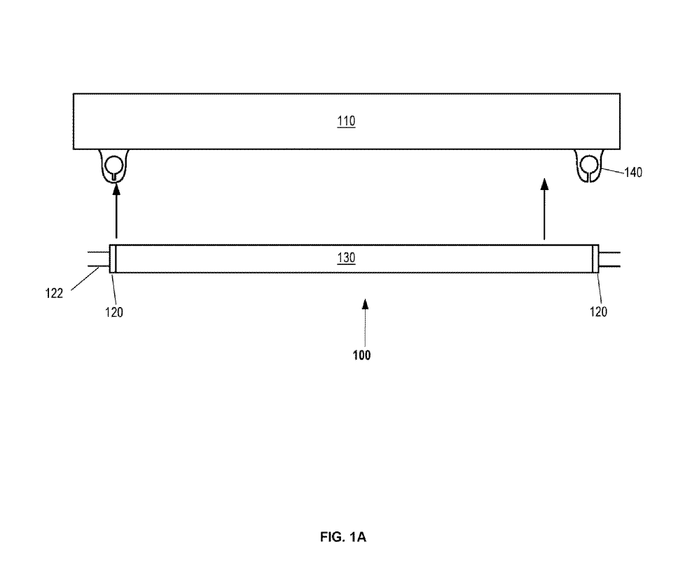

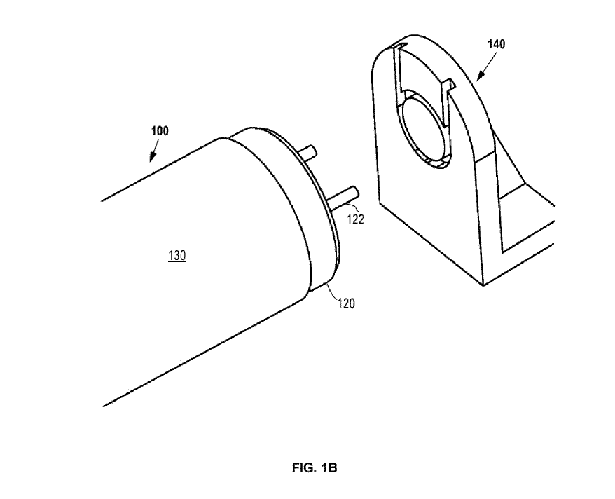

For example, as illustrated in FIG. 1A, a lighting unit 100 may be configured to replace a conventional fluorescent light tube in a conventional fluorescent lighting fixture 110. The replacement lighting unit 100 may be in a circular, linear, polygonal, curved, curvilinear u-shaped, or other form, depending upon which type of fluorescent light tube is to be replaced. Circular, u-shaped, linear, and other conventional fluorescent lamp shapes can be replaced with lighting units described elsewhere herein. The lighting unit may be in a substantially tubular form to mimic the appearance of a conventional fluorescent light tube. Alternatively, the lighting unit may have an elongated form that is not necessarily tubular. The lighting unit may have a flattened elongated form. The lighting unit may or may not have the same overall shape as the light it is replacing.

The lighting unit may have a single end cap or multiple end caps directly or indirectly connected to a light engine 130, such as a pair of end caps 120 configured to mechanically and/or electrically couple the lighting unit 100 to a conventional fluorescent light receptacle 140. Alternatively, coupling can be achieved without end caps. Coupling may be achieved, for example, through the use of conductive pins 122 protruding from the end caps 120, as is used in conventional fluorescent light tube to receptacle coupling schemes. Each end cap may have one, two, or more conductive pins, or the electrical coupling can occur at one end cap having two or more conductive pins, for example. Each end cap may also have two or more conductive pins. The pins may or may not be parallel. An end cap may contain a combination of conductive and non-conductive pins. In one embodiment, at least one of the end caps may be used only for mechanical coupling. For example, one or more end caps may couple electrically. Also, one or more end caps may couple mechanically. An end cap may simultaneously couple electrically and mechanically. Alternatively, different end caps may couple either electrically or mechanically. Further, electrical coupling may be achieved without conductive pins or features, for example, wirelessly. Mechanical coupling may be achieved in a variety of ways not including pins.

FIG. 1B is a fragmented perspective view showing one end of a lighting unit 100 with light engine 130 having an end cap 120 with conductive pins 122 configured to electrically and mechanically couple to a receptacle 140 of a conventional fluorescent lighting fixture. In some embodiments, an end cap may have a pin or other connecting feature configured to electrically and/or mechanically connect the lighting unit to the lighting fixture. The pin or other connecting feature may or may not be formed from a conductive material. A lighting unit may be slid and/or twisted into a fixture. A lighting unit may be removably attached to a lighting fixture. Alternatively, the lighting unit is not removable from the lighting fixture.

The lighting unit may be configured to be powered by line alternating current or direct current. A power converting supply may be directly integrated into the lighting unit. A power source may be provided external or integrated into the lighting unit. A power source may use the grid/utility to power the lighting unit. For instance, light emitting elements of a lighting unit may be configured to be powered by a power supply. The power supply may be an external power supply. Alternatively, the power supply may be incorporated within the lighting unit. The power supply can be internal to the lighting unit. For example, the power supply can include a local energy storage system such as a battery, ultracapacitor, or induction coil.

The power supply may provide a drive condition which is a drive voltage or current appropriate to power at least some of the light emitting elements. The drive conditions can vary with time and can be programmed to change in response to feedback from a sensor or user input. The drive conditions may or may not be controlled by a control module, discussed in greater detail elsewhere herein.

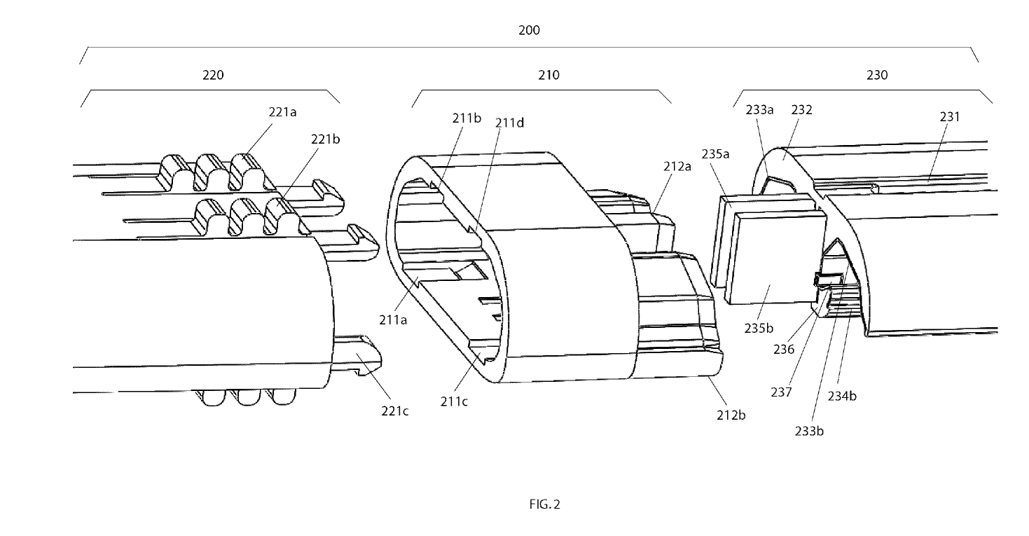

FIG. 2 is an example of a lighting unit provided in accordance with a preferable embodiment of the invention. In this figure, one end of a lighting unit is shown in a fragmented perspective view. The lighting unit 200 may be an FTR comprising a linear LED based light engine 230, the end of which may be attached to a fitting or connector 210, herein referred to as an adaptor. The adaptor may be further connected to an end cap 220 that may or may not house a power supply (not shown), also referred to as a driver. The end cap may be designed to accommodate any power supply of choice, which can include a power supply of a yet unknown design as well as a unit used in current commercial products such as LED replacement lamps.

In some embodiments, the adaptor may be permanently attached to the light engine, providing mechanical support and/or electrical connection to the light engine. Further, an end cap may be attached to the adaptor in a removable fashion such that the end cap can be exchanged while the adaptor remains. Configurations where the adaptor may not be needed are also possible. For example, the end cap may be attached directly to the light engine in a permanent or removable fashion.

Relative dimensions and shapes of modules that differ from the embodiment shown in FIG. 2 can be used with little adjustment to the functionality. For example, an end cap with a larger width/height than the adaptor or light engine may be used.

Light Engine

A light engine may be based on one or more optical elements coupled with one or more light emitting element providing illumination. A power delivery system to power the one or more light emitting elements may be provided and may include interconnection using a circuit board or other electrical means. The light engine may include a heat management part or structure. Also, the light engine may include one or more support structure and one or more reflective surfaces. Additional functionality may also be incorporated. An example of a light engine design in accordance with the above description is shown in FIG. 2.

The light engine 230 in FIG. 2 may have one or more support structure 232, one or more optical elements 233a, 233b, 236, and one or more circuit boards 235a, 235b with at least one light emitting element 237. In some embodiments, an optical element 236 may have one or more additional reflective surfaces 234b.

The circuit boards 235a, 235b may form core supportive elements for the lighting unit. The circuit boards may be of a sufficient thickness to form a supportive structure. The circuit boards may also be capable of dissipating heat. The circuit boards may be formed of a thermally conductive material. For example, the circuit board may form an aluminum core circuit board of the lighting unit. One or more surfaces of the circuit board may be exposed. In some embodiments, a surface of the circuit board opposing a surface supporting one or more light emitting elements 237 may be exposed. One or more chimneys 231 may be formed by the lighting unit through which air or other fluid may flow. A portion or all of the chimney may be formed by an exposed wall of a circuit board. An exposed surface of the circuit board may form walls of the chimney.

In some embodiments, the circuit boards 235a, 235b may be sandwiched between a support structure 232 and an optical element 236. In some instances, the circuit board may be formed with a reflective surface. In other instances, the circuit board may be partially covered with a reflective material 233a, 233b. For example, a surface of the circuit board having the light emitting elements may be partially or completely covered by a reflective material. A reflective material covering a circuit board may have one or more opening or feature that may permit a light emitting element 237 to be exposed.

The light engine, which may be an FTR LED unit, may be configured with power inputs on either end. The light engine may have a single power input on one side or power supplies on both ends. The light engine may include circuitry to transfer AC main power from one end to the other.

Further, configurations of a light engine where power is supplied in between ends are possible. For example, a power supply may be placed near the middle of a linear light or a long strip of lights. Such configurations may be advantageous for example in order to satisfy electrical requirements. Further, the light engine may have connectors in two or more directions in order to allow strings of light to be linked in arbitrary configurations. Such connectors may or may not comprise power supplies as described herein. Any description of power connectors herein may also be applied to connectors without power supplies. Daisy chained configurations using such connectors may allow almost arbitrary lengths of lighting units to be interconnected.

Power Supply

The lighting unit is configured to be powered by one or more power supplies. The power supply can be an external power supply or an internal power supply. For example, when a lighting unit is used as a fluorescent tube replacement (FTR), the ballast in a conventional fluorescent lighting fixture can be bypassed or removed and replaced with the power supply, such that when the lighting unit is electrically coupled to the receptacles of the conventional fluorescent lighting fixture, the lighting unit is electrically connected to the external power supply. The one or more power supplies may be placed in various locations, as described elsewhere within Moreover, some electrical components may or may not be located separately from a power supply.

Said power supplies may include circuitry to convert AC main power to low voltage, direct current suitable for driving an LED based light engine. Alternatively, power supplies may have power input to output configured as DC to DC, AC to AC as well as DC to AC. For example, a power supply may be supplied with DC current in applications where a building or an outdoor venue is wired with DC current. Power supplies may also include additional capabilities including but not limited to dimming, occupancy sensing, daylight harvesting, conducted control signals (such as DMX), or compatibility wireless communication protocols.

The power supply can be configured to convert wall alternating current to direct current to power the light emitting elements. The power supply may be compatible with 120 VAC input power, 230V input power or other AC and/or DC main voltages. Power supplies may be specific to a single main voltage supply or have a capability to handle two or more input voltages.

For example, when two power supplies are used, power supplies may be configured to each provide power to a portion of the light engine so that failure of one power supply will not result in a total loss of light. Power supplies may also be designed to provide a portion of the power to the light engine so that failure of one results in a lower light output from all LEDs.

The power supply can comprise a control module that can be used to drive light emitting elements based on information gathered from a sensor, electronic interface, user input or other device, for example. Information transfer may include wired, wireless or optical based communications. The control module may individually address and control the light emitting elements to adjust the color, pattern, brightness, light distribution or to compensate for aging, for example. The control module may be configured to modulate illumination from the light emitting elements. For instance, the control module may drive the lighting unit such that the light emitting elements flash or are activated in a pattern. Furthermore, the control module can drive the light emitting elements using pulse width modulation or amplitude modulation or a combination of pulse width and amplitude modulation. The control module can be used to dim the light output of the lighting unit.

The control module may individually control light emitting elements or groups of light emitting elements. Alternatively, all of the light emitting elements may be controlled together. The control module can control the light emitting elements in an analog or digital manner.

The control module may include a processor and/or a memory. The control module may include tangible computer readable media which may include code, logic, or instructions for performing one or more step. One or more data ports, such as for example a USB port, may be included to allow data transfer with the control module. For example, data may be uploaded to the control module and downloaded for analysis.

With continued reference to FIG. 2, a lighting unit may further include an adaptor 210, designed to mate with the light engine 230 and an end cap 220. The adaptor may or may not be permanently fixed to either connecting component. In a preferable embodiment, the cap adaptor 210 may be attached to the light engine portion using an adhesive. In such an arrangement, the cap adaptor is not intended to be removed from the lighting unit after manufacturing, whereas the cap itself may be removable from the lighting unit.

The adaptor may contain features allowing it to establish good electrical contact and strong mechanical connection to the components to which it mates. Referring to FIG. 2, these features may include one or more grooves 211a, 211b, 211c, 211d on the cap end and one or more snap fit features 212a, 212b, twist lock connections or other protrusions on the light engine end. The adaptor features may be complementary to features on the mating part. For example, the grooves 211a, 211b may be female fittings complementary to one or more male fittings 221a, 221b on the end cap, and the protrusions 212a, 212b may be male fittings meant to twist, slide, retractably click or otherwise connect to female receptacles on the light engine. The receiving features on the light engine may be designed to be compatible with and/or take advantage of the internal structure of the light engine in order to enhance the strength and support of the union. Electrical connection inside the adaptor may be provided in a variety of ways. The adaptor may contain an opening through which conducting portions of mating parts may be connected. For example, the circuit boards 235a, 235b can be made to protrude from the light engine such that they fit into the adapter, providing electrical and mechanical connection between the two, and allowing an end cap to connect to the circuit boards on the other side of the adaptor. In another configuration, the adaptor can have a conductive portion that is integral to or inserted into the adaptor in order to electrically connect the two sides of the adaptor. Such a conductive portion may be any conductive material, or it may be a structure such as a circuit board. The conductive portion may be provided inside the adaptor body, or it may be located externally, such as on the surface of the adaptor. When an electrical conduit through the adaptor is provided within the adaptor itself, appropriate electrical terminals to couple to mating parts may be established on the adaptor ends. Docking terminals may include conducting latches or pins. Other examples may include electrical coupling between flat adjacent surfaces by compression. A compression fit may be achieved for example through some of the mechanical coupling means described previously. Any arrangement of the mating features, such as reverse arrangement of male and female fittings from that described above, or additional electrical or mechanical mating features may be possible.

Alternatively, a connection may be established directly between the end cap and the light engine without a separate adaptor piece. The connection function may be incorporated into both the end of the light engine component and the end cap, as may be possible for example through clever design of the plastic end of the upper and lower reflectors 233a, 233b and 234a, 234b, respectively, as well as the end cap. The advantage to this configuration is a reduced number of parts, which may translate to reduced cost.

The end caps may be designed to easily connect and disconnect to the light engine with or without an adaptor as intermediary. These replaceable end caps allow substantial flexibility in application-specific outfitting of the light engine. In accordance with an embodiment in which the lighting unit is used as an FTR, an end cap containing a power supply may convert line power (120V AC or other) to electrical power suitable to drive the LEDs in the FTR, allowing the FTR unit to be used with existing fluorescent fixtures. The end cap may be easily switched to another end cap with a potentially different power supply or a replacement power supply.

An end cap may be configured to connect to a single light engine and/or adaptor of the light engine. Alternatively, the end cap may be capable of connecting to two or more light units simultaneously, for example to form a string of light units. In some instances, end caps may be capable of connecting to other end caps which may or may not be connected to additional light units. The end caps and/or adaptors may be designed to accommodate such connections, or additional components such as intercap adaptors may be added, with mating, electrical and mechanical functionality similar to that of the adaptors described elsewhere herein. For example, the end cap 220 shown in FIG. 2 can be designed with mating parts on both ends, wherein the light engine or adaptor mating part may be designed as described previously. The other end may have mating features appropriate for connecting to one or more other end caps and/or one or more adaptors. Connections to additional light units may be linear or in multidirectional. Mating features or connecting parts facilitating interconnection may themselves be linear or multidirectional. For example, a tee-connector or a four-way connector may be used for planar multidirectional interconnects. Three-dimensional interconnects may also be used. Interconnects may be configured in various electrically conducting configurations, with appropriate and complementary electrical, mechanical and mating features to allow reliable and easy connection.

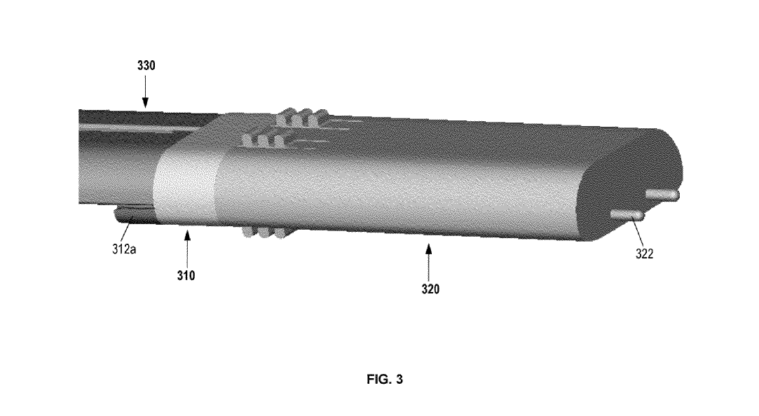

FIG. 3 shows a perspective view of one end of the lighting unit of FIG. 2. The light engine 330, adaptor 310 and end cap 320 have been connected. In this configuration, the lighting unit may be connected to a conventional fluorescent lighting fixture (not shown) using pins 322 protruding from the end caps 320. The pins may be electrically conducting, providing an electrical connection between the fluorescent lighting fixture and the end cap.

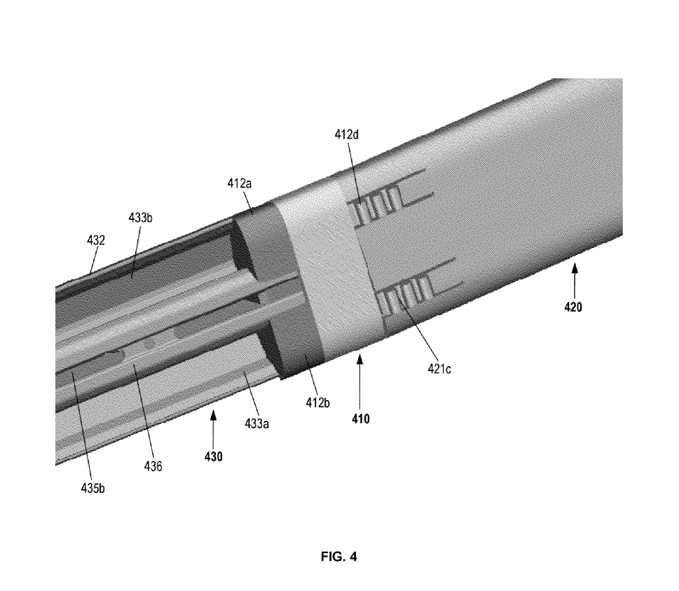

FIG. 4 is a perspective view of the same lighting unit as viewed from the direction of illumination. In the case where the lighting unit is used as a ceiling lamp, this would be a view from below. The potentially spring-loaded end cap coupling features 421c, 421d can be seen on the end cap 420. The end cap may be coupled to a light engine 430 via an adaptor 410 with coupling features 412a, 412b. The coupling features may provide a connection between the adaptor and the light engine by sliding into the light engine structure, similar to sliding into a socket.

An end cap may include additional active electronic circuitry to allow operation and compatibility with various lighting control systems including commercial dimmers, occupancy sensors, daylight harvesting, wireless lighting control protocols and other intelligent controls and features. Such features may also be located in the power supply. Active electronics may also be located elsewhere within a lighting unit or a lighting fixture.

The lighting unit may be powered by one or more power supplies housed within or connected to one or more end caps in a replaceable manner. For example, a lighting unit may have power supplies on both ends, or a string of light engines may be connected with power connectors on either or all sides. AC power may be supplied at one end of a light engine and may be carried through the light engine to the opposite end. AC feeds may not need to be connected to the same end/tombstone, in accordance with preferred FTR replacement re-wiring. The caps may be left/right interchangeable and each cap may fully power the lighting unit (at about 50% brightness) by itself The end caps may be powered by AC or DC power. At least one of the end caps may provide DC power to the LEDs. A variety of other ways to establish electrical connection between the light engine and active electronics components may also be employed.

As outlined above, a connection can be made repeatedly between a light engine and an end cap, either via a cap adaptor or directly between the light engine and the end cap. This ability is essential to enabling removable or swappable features in accordance with the present invention. In some embodiments of the lighting unit as an FTR, some electrical components may not be located inside an end cap. In one example, a power supply may be located in the ceiling above the lamp in a similar or identical location as the fluorescent ballast that is no longer required. Other electrical components, such as a radio receiver for connection to a wireless smart control system, may lie in one or more end caps.

This configuration offers several advantages. It may include easier satisfaction of UL or other compliance issues, such as avoiding high voltage to the pins in a 277 VAC building environment. Further, cost may be reduced by leveraging multiple lamps on a single power supply rather than one or more power supplies per lamp and by avoiding duplication of dimming or other components. This configuration also enables a larger power supply in the ceiling, resulting in a more suitable form factor. These advantages may be appreciated while maintaining the option to swap key features associated with electrical components located in the one or more end cap.

Power supplies, adaptors, control units and end caps may be configured as independent units, allowing each to be swapped independently. For example, a user may swap out controls while still using the same power supply unit and light engine.

The one or more end cap may be swapped out in order to install another end cap which may contain different features. Examples of customizable features that may be included in the end caps are described elsewhere within. An end cap may be removed by sliding apart, unlatching or otherwise disconnecting the previously described mating features between the end cap and the adaptor or between the end cap and the light engine. Once removed, the end cap may be replaced by another end cap having mating features also compatible with the remainder of the lighting unit. Alternatively, an end cap may contain customizable features in a modular way, such as in the form of cartridges. In such case, only certain parts of the end cap may be removed if desired. For example, an occupancy monitoring may be removed from an end cap and substituted by a wireless communication module or cartridge. Another example may be switching out an end cap with a particular power supply to an end cap with a remote power supply connection and additional optional features. One or more feature ports may be installed inside the cap to add or change features. For example, a feature port may allow wireless protocol compatibility to be changed easily.

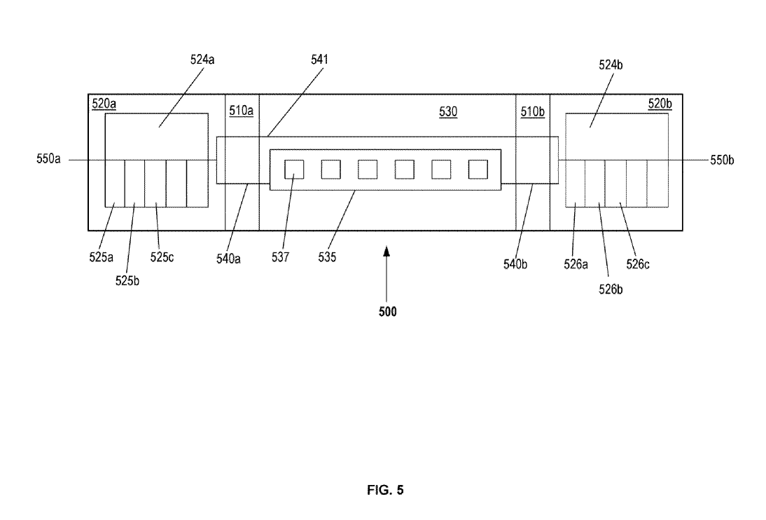

The opportunity for customization of a lighting unit according to the present invention is further illustrated by the conceptual diagram in FIG. 5, where a lighting unit 500 may be assembled from a light engine 530, one or two optional adaptors 510a, 510b, and one or two end caps 520a, 520b. The end caps may be electrically connected to external AC power inputs 550a, 550b. The light engine may contain a plurality of light emitting elements 537, which may be electrically connected individually or group-wise by a circuit board 535. Each end cap may or may not contain a power circuit 524a, 524b and additional customizable features 525a, 525b, 525c or more and 526a, 526b, 526c or more, respectively. These features may be individually or group-wise detachable as cartridges, or integral to each end cap. The end caps can be connected to the light engine either directly or via the adaptors. Each interconnection may include a DC power interconnect, such as 540a and 540b, an AC power interconnect, such as 541, or both. The DC power may be used to power all or some of the light emitting elements, which may be LEDs. The AC interconnects may transfer power through the inside of the light engine, for example to the other end of the light engine.

This versatile structure may allow for a multitude of combinations. To illustrate this concept, a single AC feed 550a may power both ends of the lighting unit. AC power may be provided to the power supply 524a and also transferred via interconnect 541 to the power supply 524b. In this arrangement, DC power to the LEDs may be provided by either one of the end caps, or both. Further, optional features may be added to either end cap, or both, and the selection of features may or may not be the same. It can be appreciated that the foregoing example is just one of many possible configurations. The customization can further include making adjustments to external shapes of modules, such as making an end cap that contains fewer components smaller than an end cap with many components in order the make the overall length of the lighting unit suit user constraints.

Methods

A method for illumination may include providing a lighting unit with one or more of the characteristics as previously described. For example, a method of illumination may include providing a light engine module with a power supply module such that the modules may be connected and separated in a reproducible manner. More generally, the method may include locating selected active electronics components in a detachable module, which may be referred to as a customizable electronics module, to enhance the ability of a lighting unit to be tailored and serviced according to user needs. To illustrate, active portions of a lighting unit may be easily upgraded (optical sensing can be added, for example) or replaced (a failed power circuit can be replaced, for example). The coupling may be provided between modules using custom fittings designed to reliably connect and disconnect modules. In some embodiments, the method may include locating modules differently or adding one or more mating parts according to user needs and compatibility with existing systems. Furthermore, methodology for how to best locate and electrically and mechanically interconnect modules may be provided.

A method may be provided for assembling the lighting unit. For example, the method of assembly may include fitting modules together such that a reliable electrical and mechanical connection can be made every time. The method may include attaching the various modules using one or more connectors or fitting modules into one another without using fittings. A further step may include affixing selected components permanently while retaining removability of other components.

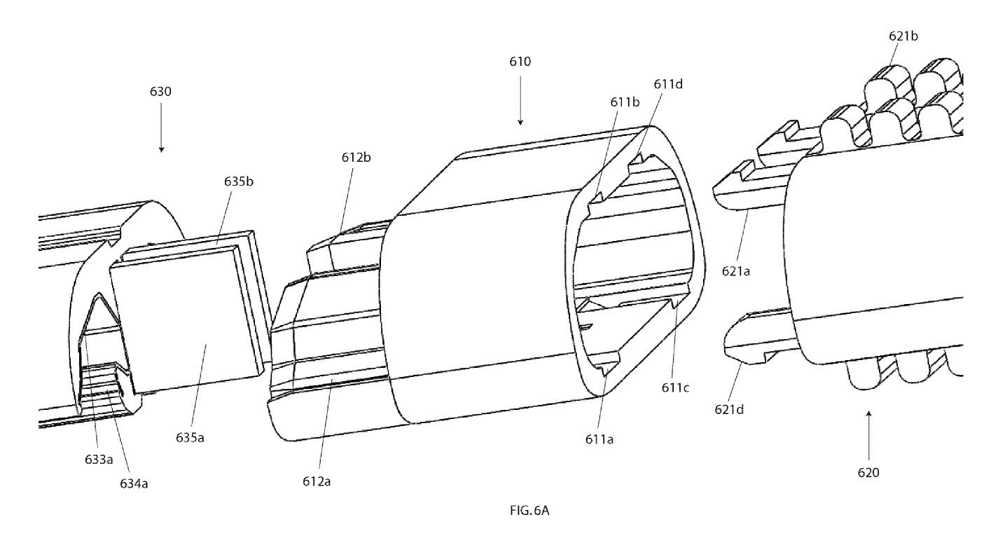

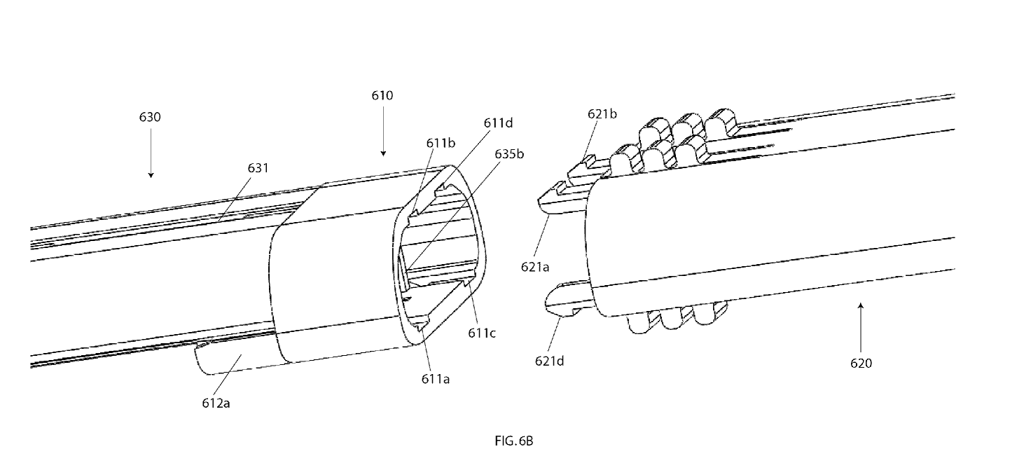

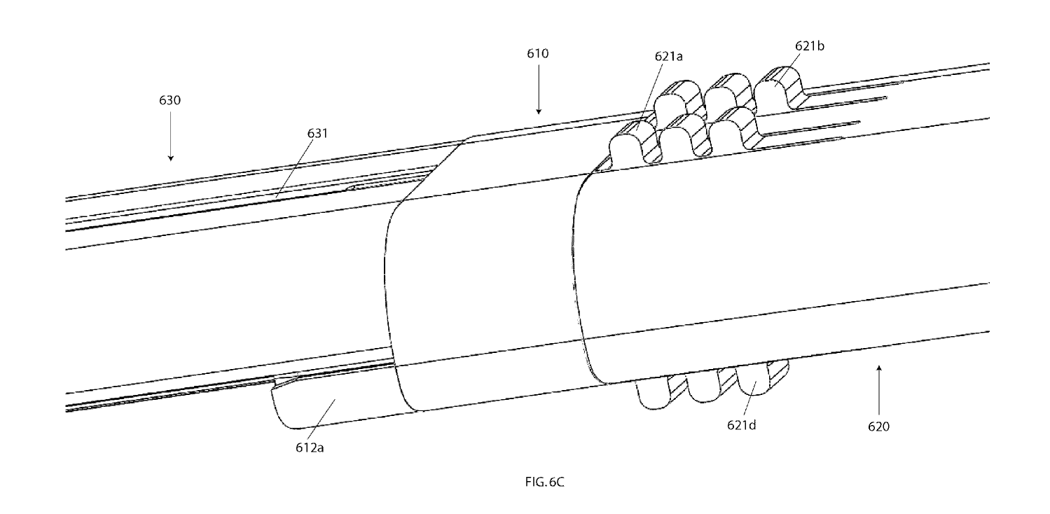

Views illustrating the assembly of a lighting unit in accordance with a preferable embodiment are shown in FIGS. 6A, 6B and 6C. The sequence of steps shown illustrates how a lighting unit might be installed and removed in the field. In FIG. 6A, an adaptor 610 is mated with a light engine 630 by fitting together mating features including 612a, 612b on the adaptor with protruding circuit boards 635a, 635b and hollow spaces formed by features including 634a, 633a and 631 on the light engine. Additional features partaking in the connection are not visible.

The resulting assembly is shown in FIG. 6B, where now an end cap 620 is connected to the assembly on the left via mating features including 621a, 621b, 621d on the end cap and 635a, 635b, 611a, 611b, 611c, 611d and other features not visible here on the two-part assembly on the left. The circuit boards 635a, 635b may provide electrical connection throughout the final three-part assembly shown in FIG. 6C. This assembly method just described illustrates one of many ways in which a system in accordance with the present invention may be assembled.

A method for manufacturing of the lighting unit may also be provided which includes mixing and matching light engine modules with other modules, such as power supplies housed in end caps, taking advantage of standardized mating features such as those described above. As an example, a whole line of FTRs could be manufactured using a single light engine module paired with independently produced power supplies with different configurations and capabilities.

Advantages

The invention provided herein may offer significant performance and cost advantages. A highly efficient lighting unit may be provided with low cost and improved serviceability, upgradability and customizability. These advantages are made possible through a system designed to allow reproducible attachment and detachment of modules with different functionalities.

For example, a removable power supply may be replaced in case of failure, resulting in better serviceability of the lighting unit.

Another benefit of the invention is that further developments in power supplies may be added at a minimal cost without replacement of the entire unit. This enhancement of the functionality of a lighting unit by switching out the driver in order to keep pace with new developments in lighting control and technology is the basis for enhanced upgradability. For example, a base power supply may only provide power to the LED module. This base unit could be replaced with a new power supply unit that would be compatible with existing dimmer circuits. Alternatively, other versions of the power supply that allow use with different line voltages (i.e. 120V AC, 220V AC, 347V AC, etc.) or even compatibility with currently installed ballasts may be selected. Additional control capability, such as dimming via occupancy sensing and daylight harvesting could also be added to installed FTRs at minimal cost.

Further, enhanced customizability is made possible by mixing and matching a light engine with different driver modules, such as detachable/switchable power supplies customized to include features such as energy saving and “smart” technologies, line voltage compatibility features and wireless or optical based communications for light control tailored to fit the user's lighting application. Further customizable features may include temperature and efficiency feedback, error detection, remote control, color control, scheduling and power input optimization. Communications and controls features may apply to individual lighting units or parts thereof, or to groups of lighting units. Lighting units may be able to communicate with each other, with a master or both.

This customizable approach may translate to reduced manufacturing cost of FTRs, since an entire line of FTRs could be produced by adding different power supplies produced separately to any light engine module as needed to produce a wide range of final products.

Further justification to this approach is provided by the comparatively long lifetime of the core component of an LED based lighting unit, which is the light emitting element assembly itself. It can be recognized that replacements or upgrades to components auxiliary to this core component may be necessary throughout the lifetime of the LEDs. The present invention seeks to realize this approach.

A further advantage of the present invention concerns the ease with which a lighting unit can be assembled and modules can be switched out. This field replacement capability and ease of handling may result in wider adoption of such a lighting unit system.

Using the lighting unit in accordance with an embodiment of the invention as an FTR lamp can have several advantages. The lighting unit can provide higher efficiency, thus decreasing the global amount of electricity used for lighting. In addition, such a lighting unit can provide reduced carbon dioxide emissions from the generation of electricity to power the light source and can eliminate the need for lamps containing mercury which poses risks to human health and the environment. It is estimated that two to four tons of mercury are produced annually in the U.S. from the 500 to 600 million fluorescent tubes discarded. Furthermore, higher quality light for an improved human visual experience can be provided. For example, the color and brightness can be independently tuned while maintaining high efficiency. Increased productivity can also result from improved quality of light. Furthermore, the lighting unit of the present work can be dimmable or provide other advanced control features. Further time and cost saving can be drawn from the present invention in that the lighting unit is easily installed, repaired or upgraded.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A lighting unit comprising:
a lighting module; and
one or more customizable electronics modules, wherein the one or more customizable electronics modules are compatible with the lighting module and are configured to be connected and separated with the lighting module in a reproducible manner.

2. The lighting unit of claim 1, further comprising a control module configured to drive the lighting module.

3. The lighting unit of claim 1, further comprising one or more end caps configured to be connected and separated with the lighting module in a reproducible manner.

4. The lighting unit of claim 3, further comprising one or more adaptors configured to connect the lighting module with the one or more end caps.

5. The lighting unit of claim 3, wherein the one or more end caps are configured to house and/or to connect and separate with one or more power supplies and/or one or more customizable electronics modules in a reproducible manner.

6. The lighting unit of claim 3, wherein the end caps are configured to connect two or more lighting units simultaneously in a multidirectional manner.

7. The lighting unit of claim 1, further comprising one or more power supplies configured to provide a drive condition for the lighting module.

8. The lighting unit of claim 7, wherein the one or more power supplies are located internally to the lighting unit.

9. The lighting unit of claim 7, wherein the one or more power supplies are located externally to the lighting unit.

10. The lighting unit of claim 7, wherein the power supplies comprise power conversion circuitry and/or active electronics.

11. The lighting unit of claim 1, wherein the lighting module further comprises one or more power inputs and one or more AC and/or DC power interconnects.

12. The lighting unit of claim 1, wherein the lighting module is configured to be attached to a lighting fixture.

13. A method of lighting unit assembly customization comprising:
providing a lighting module;
providing one or more compatible electronics modules with different functionalities; and
connecting and separating the lighting module and the compatible electronics modules in a reproducible manner to create customized lighting unit assemblies.

14. The method of claim 13, further comprising removing one type of compatible electronics module and adding another compatible electronics module of a different type.

15. The method of claim 13, further comprising removing one type of compatible electronics module and adding another compatible electronics module of the same type.

16. The method of claim 13, further comprising providing one or more power supplies configured to provide a drive condition for the lighting module, and connecting and separating said one or more power supplies with the lighting module in a reproducible manner.

17. A lighting system comprising:
a first lighting unit comprising a first light engine;
a second lighting unit comprising a second light engine; and
one or more connectors capable of separably connecting the first lighting unit to the second lighting unit.

18. The lighting unit of claim 17, wherein the connectors are configured to allow connections between lighting units in one, two or more spatial directions.

19. The lighting unit of claim 17, wherein the connectors comprise a power supply.
